(19) United States
(12) Patent Application Publication
(10) Pub. No.: US 2023/0069414 A1
(43) Pub. Date: Mar. 2, 2023

(54) Stable and Cleat Extraction Tool

(71) Applicants: John Bardo, Grass Valley, CA (US); Ronald Teeman, Reno, NV (US)

(72) Inventors: John Bardo, Grass Valley, CA (US); Ronald Teeman, Reno, NV (US)

(21) Appl. No.: 17/410,857

(22) Filed: Aug. 24, 2021

(51) Int. Cl. B25C 11/00

(52) U.S. Cl. CPC B25C 11/00

(57) ABSTRACT

This invention relates to an improved staple and cleat removal tool more particularly to a staple removal tool designed to remove staple from hardware floors without risk of marring the wood surfaces thereof. The extraction tool device is composed of a handle integral into a flat plate shaft having a bottom prying member disposed at the other end thereof the prying member having a round edged semicircular about which the prying tip can be rotated when engaging surface abuts an underside of a crown portion of the staple. The prying tip has a wedge-shaped portion adapted to slide under the staples which firmly hold the staple in a fixed position after removal. This improved staple and cleat removal tool remover has a very distinct shape, but the contours do more than just provide a nice aesthetic component it also helps to give you leverage to pull out heavy duty staples and cleat.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates generally to an extraction tool, and more particularly to a hand-operated prying tool for pulling staples and cleats from hardwood floors.

### BACKGROUND OF THE INVENTION

In the installation of tongue and groove hardwood plank flooring materials, pneumatic staplers are commonly used to drive staples used to adhere the planks to the floor. These staplers are designed to sit flat on top of the hardwood plank and locate against a tongued side of the plank such that they can precisely drive the staple at a 45 degree angle at a point just above the tongue.

There are two major types of staple removers, namely the pincher type remover having a pair of coaxing jaws, and a prying type remover. The prying type remover usually includes a long, flat tip which can slide under the base of a staple to pry the legs of the staple from the object to which it is attached.

Tools for prying object apart or for removing one object from another (such as a nail from a piece of wood) are quite common. Typically, a prying tool is of a robust metallic design and coarse construction, lending it high strength in most situations but not providing as much utility in situations where more careful movements are required.

Commonly, pry bars (or crowbars) are of elongated design, constructed of heavy-gauge steel and having one flattened end and one curved end with a flattened terminus. At either or both of the ends of the pry bar, the flattened portion may be configured with a notch for grasping and removing nails embedded in wood or other materials. Similarly, a hammer having a nail-removing claw may include a tapered slot con-figured to grasp a nail. In each case, the prying tool (be it a hammer, a pry bar, or another specialized tool) often utilizes the nail-grasping portion in conjunction with an integral ful-crum to lever a nail or other fastener out of the material in which it is lodged.

However, a traditional pry bar or hammer is often not the right tool for such a job, and the staple removal operation is left incomplete or is not accomplished efficiently. For example, the prying member of such a tool may be too large to engage the staple crown properly, such as to provide adequate leverage for removal. Additionally, if care is not used during staple removal with such a tool, one or both legs of the staple may break from the crown and remain lodged in the material, or the crown itself may snap, such as due to uneven distribution of upward force when leverage is applied, or lateral force when the tool engages the staple, and so forth.

As another option, a specialized staple-removal tool (or 65 staple puller) may be utilized, yielding a potentially more effective removal operation. In this case, however, the specialized tool design may require additional labor cost, with the tradeoff for complete staple removal being a slower removal process.

Other factors complicating an efficient and expedient 5 staple removal process includes erratic or non-uniform staple size, placement, density, and/or alignment over a given area, non-uniform crown clearance from the substrate material, and so forth. Also, in many applications, it is desirable to remove staples from a substrate material in a manner that not only leaves the substrate installed (such as wood flooring), but also preserves or minimizes damage to the surface thereof (such as if it is desired to re-use, or even refinish, the wood flooring).

In construction, more labor means higher cost. A small amount of time saved in pulling each spent nail from various surfaces in a building during a remodeling project can mean significant labor savings when the time savings for all of the craftsmen for the duration of the remodeling project are tallied. In short, a better nail removal tool allows talented craftsmen to spend their time on more challenging tasks.

### BRIEF DESCRIPTION OF THE INVENTION

The primary object of the present invention is to provide a prying hand tool, for the extraction of staples and cleats from hardwood tongue and groove flooring planks. A staple and cleat extraction tool includes a handle attached to the flat plate shaft with prying member disposed at one ends, having a flat head section terminating in a chisel, distal edge, and forming an integral fulcrum between the shaft and the chisel distal edge.

The distal edge consists of parallel, wedge-like prying tip, separated by a square notch, tapering along its length to a sharp point at the tip, which is rounded across its width. The taper may be achieved via a forward beveled surface on the top face of the prying tip. The width of the prying tip may also taper from the bottom to the top face, with the top edges rounded and/or beveled. The configuration allows the prying tip to engage a staple and, then gradually straighten and lift it by distributing upward force evenly thereto, reducing staple breakage, and the rounded notches prevent the staple legs from lodging in the tool.

A rigid fulcrum is integrally formed in the lower section of the shaft, generally perpendicular to the axis of elongation of the shaft, about which the prying hand tool can be rotated when the engaging prying tip surface abuts an underside of the crown portion of the staple.

For example, the chisel forward edge of the prying tip may ease entry into a staple body by smoothly engaging the crown of a staple, and may also provide a self-aligning feature, for example if the tooth tip engages the staple body at an angle. The wedge shape of the prying tip allows enable engagement of staple crowns with limited vertical clearance, staple crowns that are flush with the material in which the staple is engaged.

### BRIEF DESCRIPTION OF THE DRAWING

FIG. 1 is a perspective view of the staple and cleat extraction tool of the present invention illustrating its engagement with a U-sharp staple in a flat surface of a work piece.

FIG. 2 is a perspective view of the staple and cleat extraction tool according to the present invention.

FIG. 3 is an exploded view of the staple and cleat extraction tool shown in FIG. 2, showing the construction of the present invention.

FIG. 4 is a side view of the staple and cleat extraction tool shown in FIG. 2, showing the flat plate shaft, the handle at one end, round pipe on the side and the prying tip at the other end.

FIG. 5 is a perspective view of the prying tip of the present invention having a chisel portion at the end and a rectangle notch along its length.

FIG. 6 is a front elevation view of the rectangle cleat notch according to an embodiment of the present invention of FIG. 2.

FIG. 7 is a cross-section of a hardwood plank showing the staple and cleat extraction tool engagement with a U-shape staple position in the bottom of a channel illustrating commencement of the prying action.

FIG. 8 is a side perspective view of cleat notch illustrating its initial engagement with a cleat position in the bottom of a plank channel.

### DESCRIPTION OF CERTAIN EMBODIMENT OF THE PRESENT INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

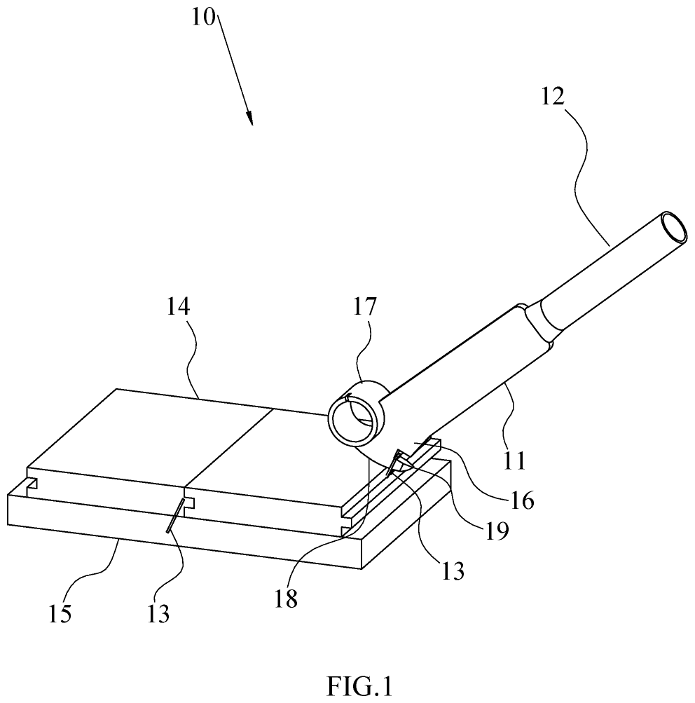

The present invention shown in FIG. 1 illustrate one version of the staple and cleat extraction tool 10 position over a U-shape staple 13 which is partially embedded into the side of the flooring plank 14 attaching it to the subfloor 15. The staple and cleat extractor tool 10 of the present invention includes a flat plate shaft 11 and a handle 12. Head portion 16 includes a fulcrum pipe 17, a bottom surface 18 and the prying tip 19.

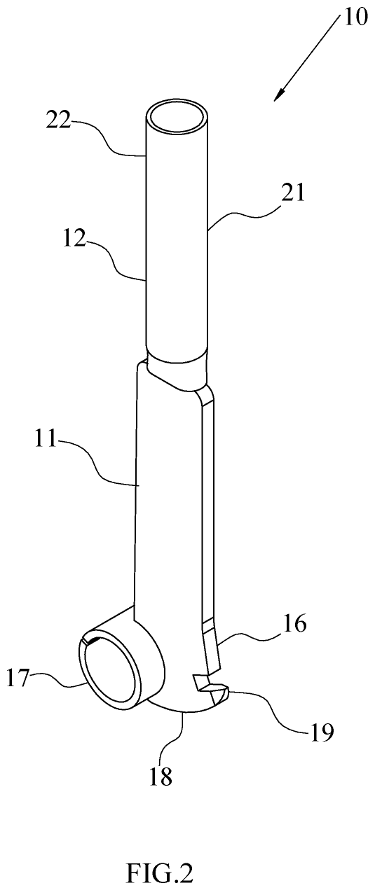

As shown in FIG. 2, is a perspectives view of the staple and cleat extraction tool 10 in accordance with the present invention includes a flat plate shaft 11, a handle 12 and fulcrum pipe 17. Flat plate shaft 11 includes a top handle pipe 21, with a handle grip 22 attached, a bottom head portion 16 with fulcrum pipe 17 attached to the head portion 16.

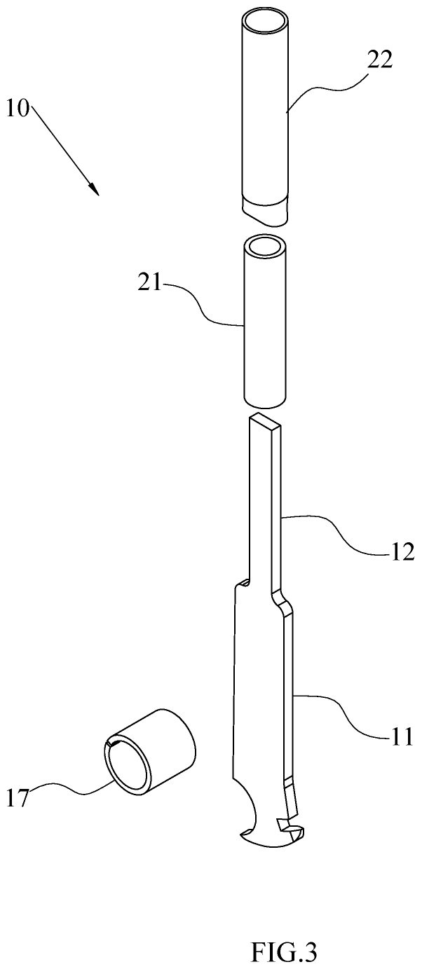

As substantially shown in FIG. 3, an exploded view of the staple and cleat extraction tool 10 showing the relationship between the major components including the flat plate shaft 11, handle 12, handle pipe 21, the fulcrum pipe 17 and the handle grip 22 which is an important feature of the present invention.

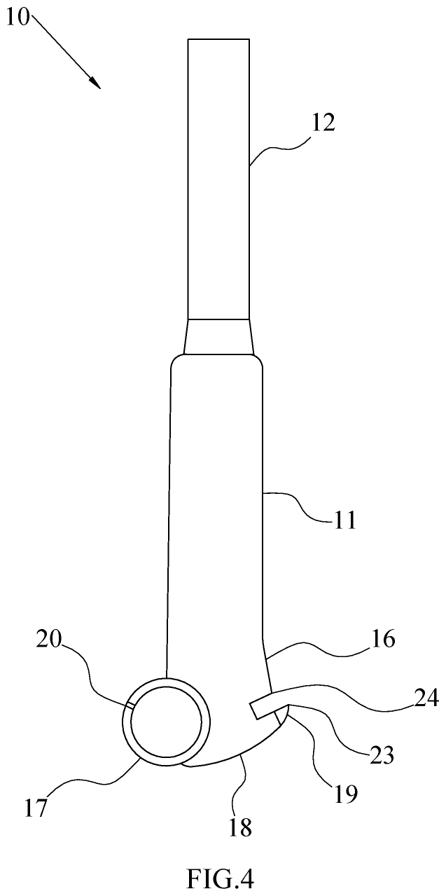

FIG. 4 is a side view of the staple and cleat extraction tool 10 shown in FIG. 2, showing the flat plate shaft 11, the handle 12 at one end, round pipe 17 on the side with the cleat notch 20 and the prying tip 19 at the other end. The staple removal prying tip 19 has a central project nose 23 which is substantially aligned with axis of the elongation notch 24 of the head portion 16. Bottom surface 18 is preferably smoothly curved and serves as a lever with a moveable fulcrum pipe 17.

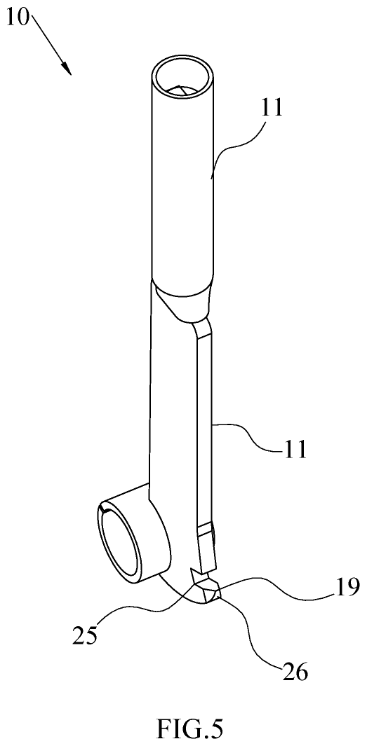

In accordance with embodiment of the present invention FIG. 5, is a perspective view of the staple and cleat extraction tool 10, flat plate shaft 11 with a generally tapered contoured distal prying tip 19 specially configured to efficiently remove staples from both flat and non-flat surfaces without causing any damage. The prying tip 19 also includes a beveled surface 26 allowing the prying tip 19 to engage a staple, then gradually straighten and lift it by distributing upward force evenly thereto, reducing staple breakage. The prying tip 19 having a rectangle notch 25 prevents the staple legs from lodging in the tool.

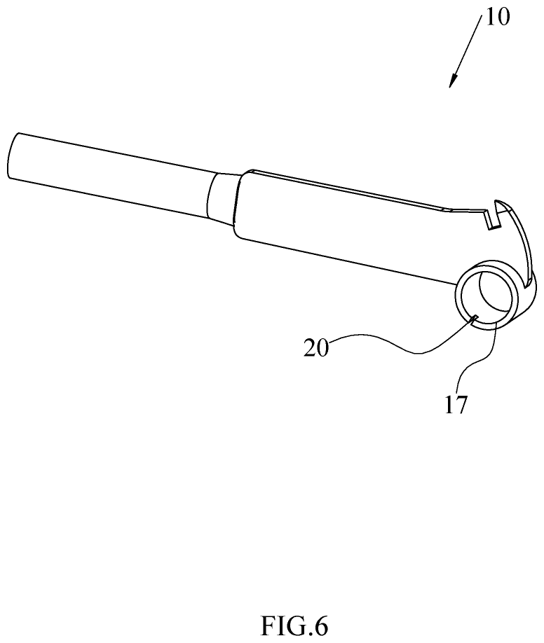

As generally shown in FIG. 6 is a front elevation view of staple and cleat extraction tool 10 showing the rectangle cleat notch 20 herein part of the round pipe 17 according to an embodiment of the present invention.

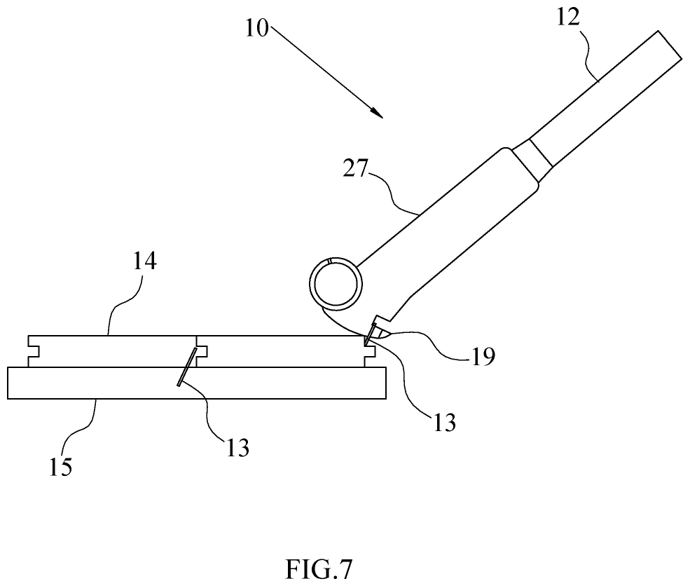

In FIG. 7 the staple and cleat extraction tool 10 is positioned over a U-shape staple 13 which is partially embedded in a flooring plank 14. These U-shape staple 14 are used to attach the flooring planks to the sub floor 15. The prying tip 19 at one end and the handle 12 at the opposite end create a lever arm movement 27 because when the staple and cleat extraction tool 10 is used, the tool pivots around the bottom surface 18 providing a mechanical advantage for the user to remove the staple.

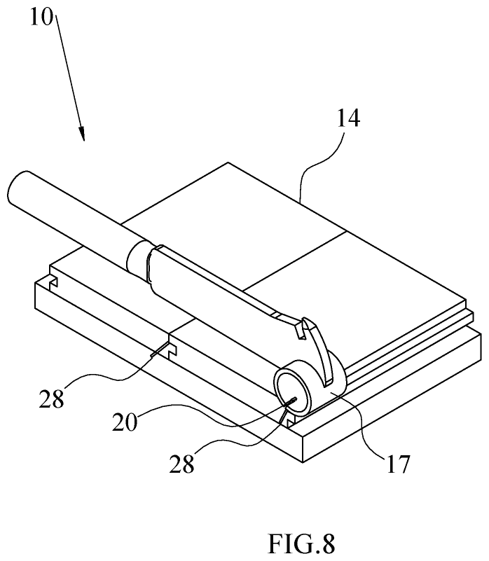

Moreover, as shown in FIG. 8 is a side perspective view of cleat notch 20 illustrating its initial engagement with a typical hardwood cleat 28 position in the bottom of a flooring plank 14 channel. The cleat notch 20 is inserted into the cleat 28 at a 45 degree angle and once the cleat 20 is engaged then the staple and cleat extraction tool 10 can be rotated using the round pipe 17 in a forward direction along the flooring plank 14 surface removing the cleat 28.

What is claimed is:

1. A staple and cleat extraction tool comprising:
a flat plate shaft, a handle and head portion includes a fulcrum pipe, a bottom surface and the prying tip and
a beveled surface allowing a prying tip to engage a staple, then gradually straighten and lift the staple by distributing upward force evenly thereto, reducing staple breakage and
a rectangle notch prevents the staple legs from lodging in the tool.

2. The stable and cleat extraction tool of claim 1, wherein the handle is integral into the flat plate shaft having a bottom prying member disposed at the other end thereof the prying member having a round edged semicircular about which the prying tip can be rotated when engaging surface abuts an underside of a crown portion of the staple.

3. The stable and cleat extraction tool of claim 1, wherein the prying tip has a wedge-shaped portion adapted to slide under the staples which holds the staple in a fixed position after removal.

4. The stable and cleat extraction tool of claim 1, wherein the flat plate shaft, the handle at one end, fulcrum pipe on the side with the cleat notch and the prying tip at the other end the prying tip has a central project nose which is substantially aligned with axis of the rectangle notch of the head portion.

5. The stable and cleat extraction tool of claim 1, wherein the edge consists of parallel, wedge distal edge consists of parallel, prying tip, separated by a rectangle notch, tapering along the length to a end point at the tip, which is rounded across the width, the taper may achieved via a forward beveled surface on the top face of the prying tip, the width of the prying tip may else taper from the bottom to the top face, with the top edges rounded and/or beveled.

6. The stable and cleat extraction tool of claim 1, wherein the fulcrum is integrally formed in the lower section of the shaft, perpendicular to the axis of elongation of the shaft, about which the staple and cleat extraction tool can rotated when the engaging prying tip surface abuts an underside of the crown portion of the staple.
